(19) United States
(12) Patent Application Publication
(10) Pub. No.: US 2021/0245190 A1
(43) Pub. Date: Aug. 12, 2021

(54) PAINT NOZZLE

(71) Applicant: HONDA MOTOR CO., LTD., Minato-ku, Tokyo (JP)

(72) Inventors: Takashi Kikuchi, Hagagun, Tochigi-ken (JP); Osamu Yashima, Hagagun, Tochigi-ken (JP); Koichi Ikebukuro, Hagagun, Tochigi-ken (JP)

(21) Appl. No.: 17/253,149

(22) PCT Filed: Jun. 19, 2019
(86) PCT No.: PCT/JP2019/024315

§ 371 Date: Dec. 17, 2020

(30) Foreign Application Priority Data
Jun. 20, 2018 (JP) 2018-116798

(51) Int. Cl. B05B 13/04; B05B 1/14

(52) U.S. Cl. CPC B05B 13/0431; B05B 12/00; B05B 1/14

(57) ABSTRACT

A paint nozzle used in a paint device has a paint channel that supplies paint, an air channel that supplies air, and a nozzle plate that is connected to the paint channel and the air channel. This nozzle plate is provided with a merging section that causes the paint and the air to merge and mix, and a discharge port that discharges, as paint particles, the paint and the air in a mixed state from the merging section. In addition, the interior of the nozzle plate has a tapered portion that connects the merging section and the discharge port and that tapers toward the discharge port on the distal end side.

### TECHNICAL FIELD

The present invention relates to a coating (paint) nozzle employed in a coating device for coating an object-to-be-coated such as an automobile body.

### BACKGROUND ART

In the past, an air spray system coating device has been known as a means of coating an automobile body or the like. As disclosed in, for example, Japanese Laid-Open Patent Publication No. 2003-506210 (PCT), such a coating device includes a spray nozzle and a coating nozzle that discharge a covering material. The covering material is supplied to the spray nozzle and the coating nozzle from a pump connected via a pipe and is discharged at high pressure, and the spray nozzle moves by a robot arm, whereby a surface of the object-to-be-coated is uniformly coated with the covering material.

Moreover, a coating device disclosed in Japanese Laid-Open Patent Publication No. 2006-521206 (PCT) is provided with a spray nozzle assembly configured from a nozzle main body and an air cap, and performs coating by atomization air supplied from an actuator being mixed with a liquid such as a coating material to render the liquid mist-like, and the liquid being further rendered mist-like by fan air supplied through the air cap and then being discharged.

### SUMMARY OF INVENTION

In the above-mentioned coating devices of Japanese Laid-Open Patent Publication No. 2003-506210 (PCT) and Japanese Laid-Open Patent Publication No. 2006-521206 (PCT), since a structure has been adopted in which the covering material (the liquid) discharged from a tip of the spray nozzle and air are collided to become a mist, high-precision control of air pressure of the air and discharge pressure of the covering material is required.

However, in a process where the air and the coating material such as the covering material are mixed and turned into a mist by the above-mentioned control of the air and the coating material, particles of the coating material fly off outwardly in a discharge direction, hence coating efficiency of the coating material with respect to the object-to-be-coated ends up falling, and, in order for a coating film to be obtained in a required range in the object-to-be-coated, time must be taken for an overspray to be performed.

As a result, as well as the coating material such as the covering material ending up being unnecessarily wasted and an increase in manufacturing costs being incurred, an operation rate of a recovery facility for recovering the excess coating material increases, and, accordingly, electric power consumption ends up increasing. Moreover, time for cleaning the coating material that has become attached to a facility such as a coating robot and for performing maintenance becomes required, and a further increase in manufacturing costs ends up being incurred.

A general object of the present invention is to provide a coating nozzle that enables a coating film to be formed uniformly and efficiently on a desired region of an object-to-be-coated, and enables a reduction in manufacturing costs and a shortening of manufacturing time to be achieved.

An aspect of the present invention is a coating nozzle including: coating material supplying channels configured to supply a coating material; fluid supplying channels configured to supply a fluid; and a body in which the coating material supplying channels and the fluid supplying channels are connected, the body being provided with a merging portion configured to merge and mix the coating material and the fluid, and at least one discharge port configured to discharge the coating material and the fluid in a mixed state from the merging portion, wherein the body includes, on an inside thereof, the merging portion, the discharge port, and a taper portion that tapers from the merging portion toward a tip side of the discharge port.

According to the present invention, a coating nozzle, which includes a body in which coating material supplying channels for supplying a coating material and fluid supplying channels for supplying a fluid are connected, is provided with a taper portion that tapers from a merging portion of the body where the supplied coating material and fluid are merged toward a tip side of a discharge port configured to discharge coating material particles formed by mixing the coating material and the fluid.

Hence, in the merging portion inside the body, when the coating material and the fluid are each distributed to the tip side of the body and discharged to outside from the discharge port in a state of having been mixed in the merging portion, the coating material that has undergone mixing (the coating material particles) passes (pass) along the taper portion from the merging portion to be suitably guided to the discharge port along an inner wall surface. As a result, uniformity of the coating material discharged from the discharge port can be improved and ability-to-advance-linearly of the coating material can be enhanced, hence a desired region in the object-to-be-coated can be uniformly and efficiently coated by the coating nozzle. Moreover, a shortening of manufacturing time can be achieved while achieving a reduction in manufacturing costs since a used amount of the coating material can be reduced.

### BRIEF DESCRIPTION OF DRAWINGS

FIG. 1 is a schematic perspective view showing a coating robot in which a coating device including a coating nozzle according to an embodiment of the present invention has been installed;

FIG. 2 is an external appearance perspective view of the coating device shown in FIG. 1;

FIG. 3 is an overall side view of the coating device shown in FIG. 2;

FIG. 4 is a cross-sectional view taken along the line IV-IV of FIG. 3;

FIG. 5 is a cross-sectional view taken along the line V-V of FIG. 4;

FIG. 6 is an external appearance perspective view of the coating nozzle configuring the coating device of FIG. 2;

FIG. 7 is an exploded perspective view of the coating nozzle shown in FIG. 6;

FIG. 8 is an overall cross-sectional view of the coating nozzle taken along the line VIII-VIII of FIG. 6;

FIG. 9 is a passage perspective view in which a coating material passage and an air passage in the coating nozzle shown in FIG. 8 have been schematically rendered;

FIG. 10 is a cross-sectional view with partial omissions taken along the line X-X of FIG. 6;

FIG. 11 is an enlarged cross-sectional view of a vicinity of a discharge port in FIG. 10; and

FIG. 12 is an enlarged cross-sectional view showing a vicinity of a discharge port in FIG. 8.

### DESCRIPTION OF EMBODIMENTS

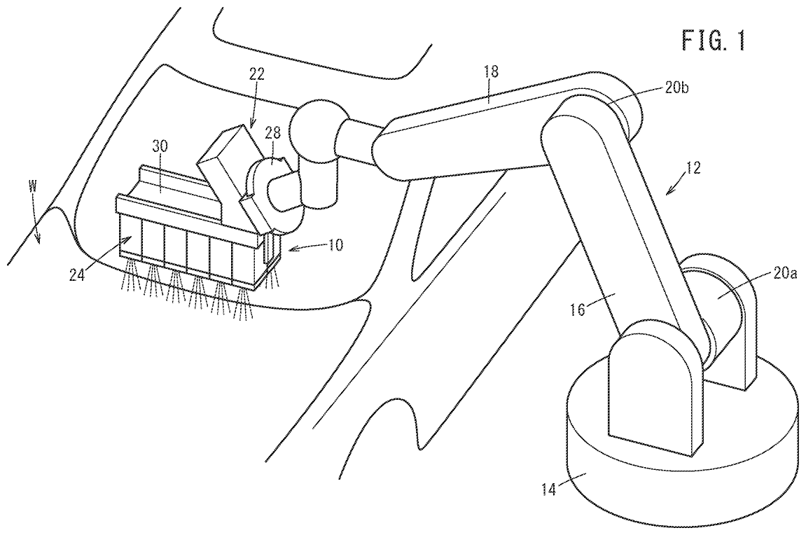

As shown in FIG. 1, this coating device 10 is provided in a coating robot 12 installed in a coating line of a factory or the like, and, for example, by discharging a coating material onto a target object (an object-to-be-coated) W such as a body of a vehicle, or the like, forms a coating film on a surface of the target object W.

First, the above-mentioned coating robot 12 will be described with reference to FIG. 1. This coating robot 12 is configured as an articulated robot, for example, and includes: a base 14 fixed to the unillustrated coating line; a first arm portion 16 extending from the base 14; and a second arm portion 18 coupled to a tip of the first arm portion 16.

Moreover, the base 14 and the first arm portion 16, and the first arm portion 16 and the second arm portion 18 are respectively coupled in a freely movable manner via joint portions 20a, 20b. Note that the joint portions 20a, 20b couple the portions (for example, the base 14 and the first arm portion 16) such that the portions can be rotated relative to each other. Moreover, the coating device 10 is provided in a freely attachable/detachable manner to a tip of the second arm portion 18.

Next, the coating device 10 fitted to the above-mentioned coating robot 12 will be described.

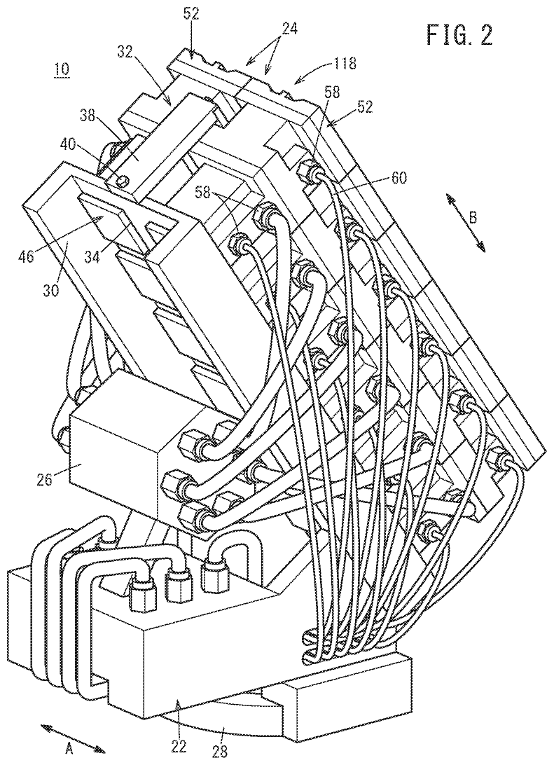

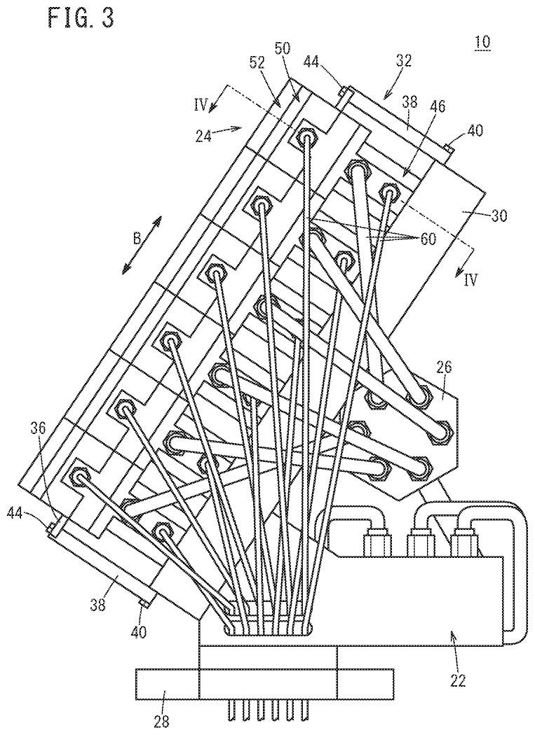

As shown in FIGS. 1 to 4, this coating device 10 includes, for example: a frame 22 fitted to the second arm portion 18 of the coating robot 12; a plurality of coating nozzles 24 installed in the frame 22; and a mixer 26 (refer to FIGS. 2 and 3) which is provided in the frame 22 and distributes a coating material to each of the plurality of coating nozzles 24. This mixer 26 is connected to an unillustrated coating material supplying device via piping, and the coating material is supplied to each of the coating nozzles 24 from this coating material supplying device. Note that there will be described here the coating device 10 including 12 coating nozzles 24.

The frame 22 is formed from a metal material, for example, and includes: a fitting portion 28 of annular shape coupled to the coating robot 12; a base portion 30 standing upright from the fitting portion 28 to hold the coating nozzles 24; and a positioning portion 32 standing upright in a center in a width direction of the base portion 30 to position the coating nozzles 24. Moreover, the fitting portion 28 is coupled to the tip of the second arm portion 18 in the coating robot 12.

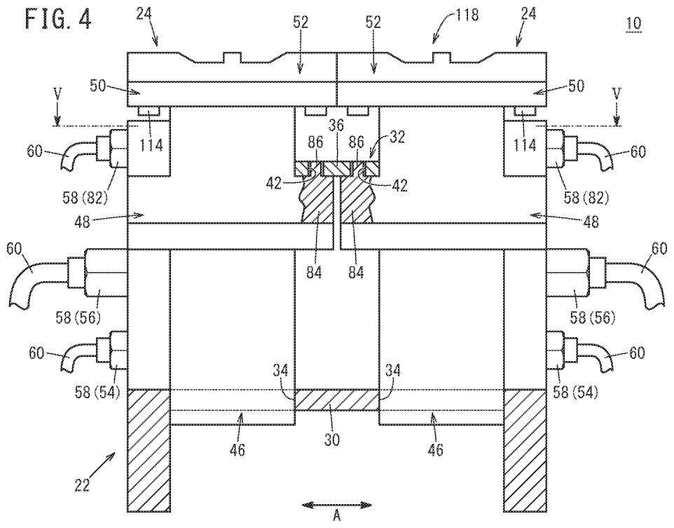

The base portion 30 is formed in substantially a U shape in cross section, stands upright extending a predetermined length obliquely upwardly from the fitting portion 28, and is formed in substantially a rectangular shape so as to have a predetermined width in the width direction (an arrows A direction in FIGS. 2 and 4).

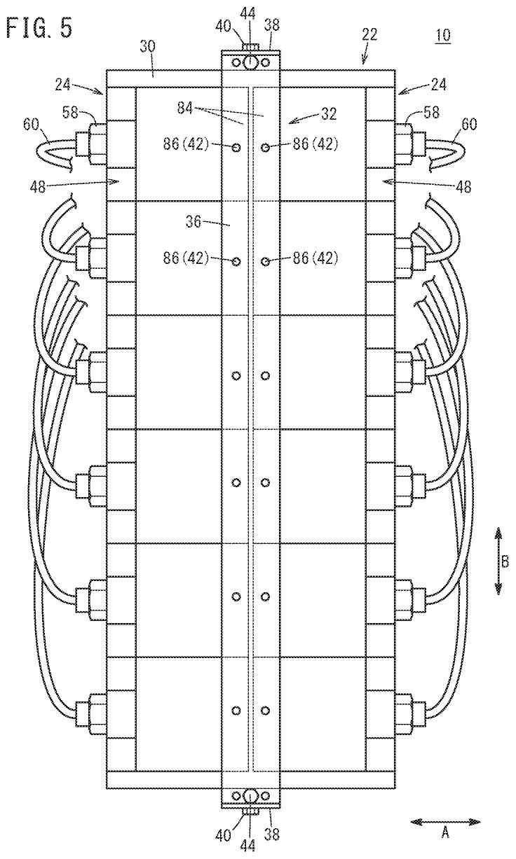

Moreover, the base portion 30 has one end surface facing the fitting portion 28, and the plurality of coating nozzles 24 are disposed on the other end surface of the base portion 30 that is in an opposite direction to the one end surface, these coating nozzles 24 being disposed in parallel in the width direction of the base portion 30 (the arrows A direction). In detail, as shown in FIGS. 2 and 5, two coating nozzles 24 are disposed in parallel in a width direction of the frame 22 (the arrows A direction), and six coating nozzles 24 are disposed along a longitudinal direction of the base portion 30 (an arrows B direction in FIG. 5), that is, a total of 12 coating nozzles 24 are provided.

Moreover, the base portion 30 has insertion holes 34 in each of which a body main body 46 of the coating nozzle 24 is inserted, and these insertion holes 34, each of which is formed in a rectangular shape in cross section and penetrates from the one end surface to the other end surface of the base portion 30, are provided in the same number as the number of the coating nozzles 24.

Note that the disposition of the coating nozzles 24 in the frame 22 and the number thereof are not limited to the above-mentioned configuration, and the required number of coating nozzles 24 may be disposed appropriately.

The positioning portion 32 is configured from: a bar member 36 provided substantially in parallel to and separated by a predetermined interval from the other end surface of the base portion 30; and a pair of legs 38 that fix both end portions of the bar member 36 to the base portion 30. These legs 38 are provided orthogonally to a center in the width direction of both end portions in the longitudinal direction of the base portion 30, and are each fixed via a bolt 40. That is, the legs 38 are provided so as to be orthogonal to the longitudinal direction of the base portion 30 (the arrows B direction), and stand upright in a direction of separating from the base portion 30.

The bar member 36 is formed in a long flat plate shape, for example, is provided along the longitudinal direction of the base portion 30 (the arrows B direction), and includes a plurality of pin holes 42 for positioning the coating nozzles 24. These pin holes 42 are provided in a number corresponding to the number of coating nozzles 24, are separated by equal intervals from each other along a longitudinal direction of the bar member 36 (the arrows B direction in FIG. 5), and are formed in two columns separated by a predetermined interval from each other in a width direction (the arrows A direction) orthogonal to the longitudinal direction.

That is, six pin holes 42 are provided along the longitudinal direction of the bar member 36, and two pin holes 42 are provided in the width direction, that is, a total of 12 pin holes 42 are provided.

Moreover, by both end portions of the bar member 36 lying along its longitudinal direction being respectively fixed to the pair of legs 38 by fixing bolts 44, the bar member 36 is held in a state of having been separated by a predetermined interval from the other end surface of the base portion 30.

Moreover, later-mentioned positioning pins 86 provided in the coating nozzles 24 are respectively inserted in the pin holes 42 of the bar member 36, whereby relative positioning of each of the coating nozzles 24 with respect to the frame 22 is performed.

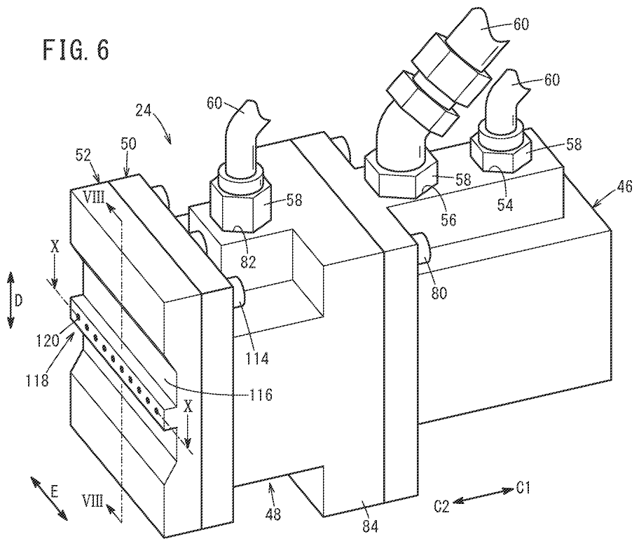

The coating nozzle 24 is provided in a freely attachable/detachable manner to the frame 22, and, as shown in FIGS. 6 to 8, includes, for example: the body main body 46; a middle body 48 covering an end surface of the body main body 46; and a nozzle plate 52 provided at a tip of the coating nozzle 24 with a cover plate 50 disposed between the nozzle plate 52 and the middle body 48. These body main body 46, middle body 48, cover plate 50, and nozzle plate 52 function as a body configuring the coating nozzle 24.

Note that description will be made assuming the body main body 46 side in the coating nozzle 24 to be a base end side (an arrow C1 direction in FIG. 6), and the nozzle plate 52 side in the coating nozzle 24 to be a tip side (an arrow C2 direction in FIG. 6).

The body main body 46 is configured from a block body of rectangular shape in cross section, and has one side surface in which there open: a pilot port 54 through which pilot air is supplied from an unillustrated pressurized fluid supplying source; and a coating material supplying port 56 through which the coating material is supplied, the pilot port 54 being formed on the base end side (in the arrow C1 direction), and the coating material supplying port 56 being formed on the tip side (in the arrow C2 direction).

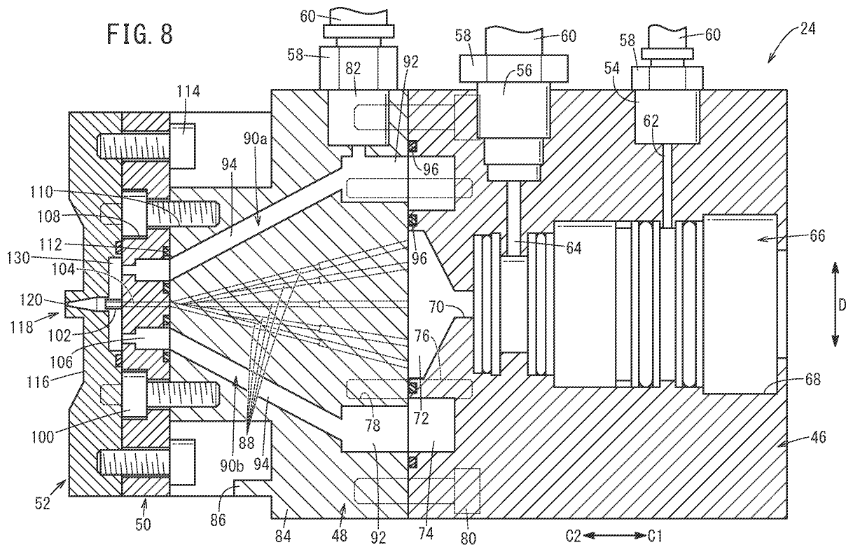

Moreover, the pilot port 54 and the coating material supplying port 56 are each connected with a tube 60 via a coupler 58. Further, the pilot port 54 and the coating material supplying port 56 respectively communicate with first and second communicating channels 62, 64 (refer to FIG. 8) that extend toward an inside of the body main body 46.

On the other hand, as shown in FIG. 8, the body main body 46 includes on its inside a housing hole 68 in which a switching valve 66 is housed, and this housing hole 68 opens at a center of a base end surface of the body main body 46 and communicates with a communicating hole 70 which is formed extending along an axial direction (the arrows C1, C2 direction) and opens at a center on the tip side (in the arrow C2 direction).

Moreover, the housing hole 68 is connected to and communicates with each of the pilot port 54 and the coating material supplying port 56 through the first and second communicating channels 62, 64.

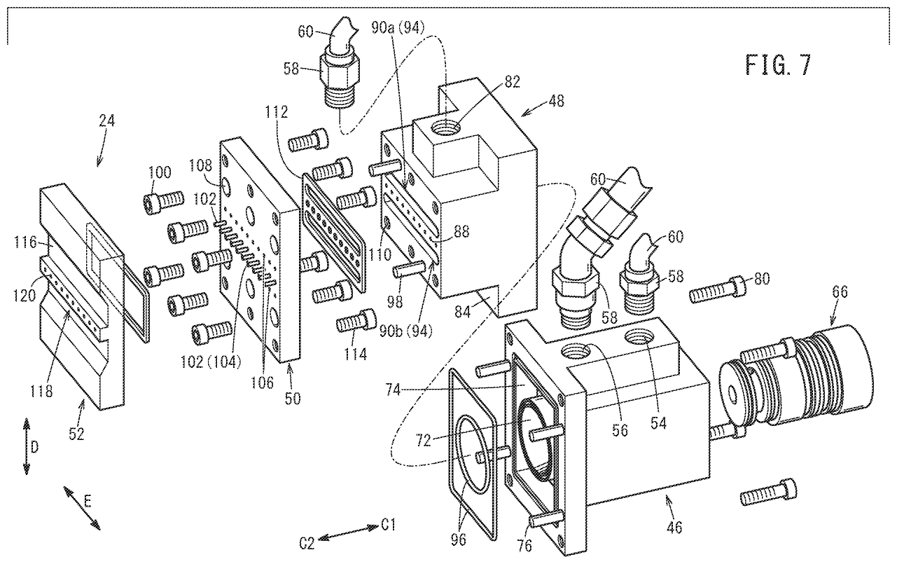

Moreover, as shown in FIGS. 7 and 8, the switching valve 66 is inserted inside the housing hole 68 from the base end side of the body main body 46 (the arrow C1 direction) to be housed in the housing hole 68, and this switching valve 66 includes on its inside a valve body (not illustrated) that performs advancing/retracting operations in the axial direction (the arrows C1, C2 direction) under action of supplying pilot air. A communicating state between the coating material supplying port 56 and the communicating hole 70 through the second communicating channel 64 is switched by movement of this valve body.

Furthermore, as shown in FIGS. 7 to 9, the body main body 46 has in its tip a coating material chamber 72 that communicates with the communicating hole 70 and whose diameter expands outwardly in a radial direction, and an air chamber 74 to which air is supplied from a later-mentioned air supplying port 82 is formed on the outer circumferential side of the coating material chamber 72.

This coating material chamber 72 has a circular shape in cross section, is formed in a center of the tip of the body main body 46, and opens facing a base end of the middle body 48. Moreover, when the coating material supplying port 56 and the communicating hole 70 communicate under switching action of the switching valve 66, the coating material is supplied to the coating material chamber 72 through the second communicating channel 64 and the communicating hole 70. On the other hand, the air chamber 74 is non-communicating with the coating material chamber 72 and formed in an annular shape so as to surround the coating material chamber 72.

Further still, the tip of the body main body 46 is provided with first coupling pins 76 at positions on an outer circumferential side of the air chamber 74, and these first coupling pins 76 project in the axial direction (the arrow C2 direction) and are respectively fitted into pin holes 78 (refer to FIG. 8) of the adjacent middle body 48. As a result, the body main body 46 and the middle body 48 are positioned coaxially, and integrally coupled by four fastening bolts 80.

The middle body 48 has a rectangular shaped cross section being substantially the same as the cross section of the body main body 46, abuts on the tip side of the body main body 46 (the arrow C2 direction) to be coupled thereto, has one side surface where the air supplying port 82 opens, and is supplied with air (a fluid) through the tube 60 connected thereto via the coupler 58. Note that this air supplying port 82 is formed on the one side surface of the middle body 48 which is flush with the one side surface of the body main body 46 where the coating material supplying port 56 opens.

Moreover, as shown in FIGS. 4 to 8, the middle body 48 includes, on its other side surface being on an opposite side to the one side surface where the air supplying port 82 is formed, a projection 84 that projects in a direction orthogonal to the axial direction (the arrows C1, C2 direction). This projection 84 is formed in a rectangular shape in cross section, and comprises the positioning pin 86 that projects from an end surface on the tip side (in the arrow C2 direction).

Moreover, when the coating nozzles 24 are each fitted to the frame 22, the positioning pins 86 are respectively inserted in the pin holes 42 of the bar member 36 in the frame 22, and each of the coating nozzles 24 is thereby positioned at a predetermined position with respect to the base portion 30 of the frame 22.

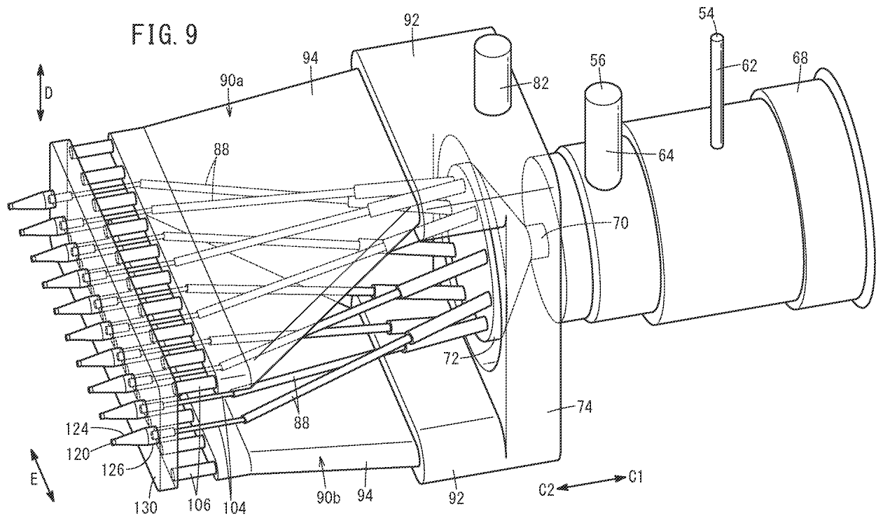

On the other hand, as shown in FIGS. 8 and 9, the middle body 48 has on its inside: a plurality of coating material passages 88 opening in a center of its base end to extend to its tip side (in the arrow C2 direction); and a pair of air passages 90a, 90b provided in an upward and downward direction (an arrows D direction) with respect to the coating material passages 88.

The number of these coating material passages 88 is 10, for example, and the coating material passages 88 have their base ends opening in the base end surface of the middle body 48 to be disposed facing the coating material chamber 72 of the body main body 46 and thereby communicate with the coating material chamber 72, and are disposed separated by equal intervals from each other along a circumferential direction correspondingly to a shape of the coating material chamber 72.

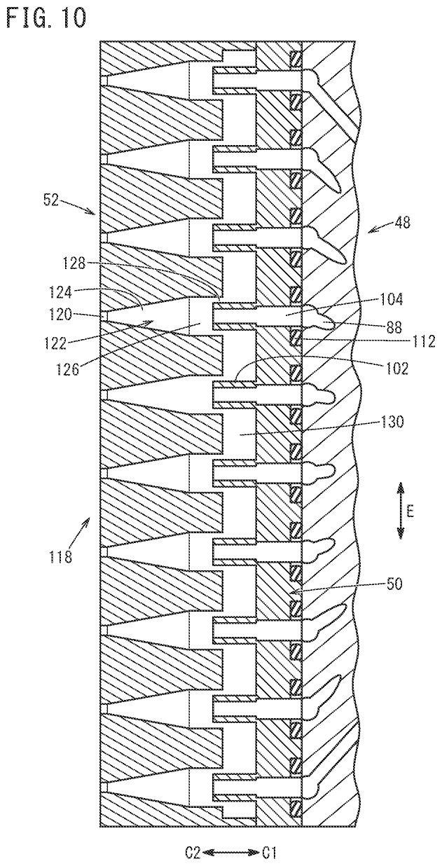

Moreover, the plurality of coating material passages 88, which are formed with the same passage diameter, incline so as to approach each other toward a center in a height direction of the middle body 48 (the arrows D direction) from their base ends disposed separated by equal intervals on a circumference toward their tip sides (in the arrow C2 direction), and, as shown in FIGS. 9 and 10, have their tip sides (in the arrow C2 direction) extending separated by equal intervals from each other in a width direction (an arrows E direction) orthogonal to the height direction.

Moreover, at the tip of the middle body 48, the plurality of coating material passages 88 each open at a center in the height direction, and, as shown in FIG. 7, are disposed linearly along the width direction (the arrows E direction) separated by equal intervals from each other. That is, these coating material passages 88 extend three-dimensionally from the base end of the middle body 48 toward the tip side (in the arrow C2 direction) such that their respective passage lengths are substantially the same.

The air passages 90a, 90b have a predetermined width in the width direction of the middle body 48 (the arrows E direction), and, as shown in FIGS. 7 to 9, are configured from: a pair of first air passage portions 92 that are formed on the base end side of the middle body 48 (in the arrow C1 direction) and that communicate with the air supplying port 82; and a pair of second air passage portions 94 that extend from tips of the first air passage portions 92 to the tip of the middle body 48. The first air passage portions 92 extend for a predetermined length along the axial direction of the middle body 48 (in the arrows C1, C2 direction), and open in the base end of the middle body 48 to communicate with the air chamber 74 of the body main body 46.

A seal ring 96 is sandwiched between the body main body 46 and the middle body 48, on each of an inner side and an outer side of the first air passage portion 92, and leakage of air through a space between the body main body 46 and the middle body 48 is thereby prevented.

The second air passage portions 94 extend so as to incline toward the center in the height direction (the arrows D direction) from the tips of the first air passage portions 92, and open at positions separated by equal intervals in the upward and downward direction (the arrows D direction in FIG. 7) from the center in the height direction at the tip of the middle body 48.

That is, at the tip of the middle body 48, the plurality of coating material passages 88 open at the center in the height direction, and the tips of the air passages 90a, 90b open in an elongated shape along the width direction (the arrows E direction) above and below these coating material passages 88 (refer to FIGS. 7 to 9). In detail, one air passage, namely, the air passage 90a formed on an upper side, and the other air passage, namely, the air passage 90b provided on a lower side are formed in a forked shape symmetrical in the height direction of the middle body 48 (the arrows D direction).

Moreover, the tip of the middle body 48 is provided with second coupling pins 98 (refer to FIG. 7) at positions above the air passage 90a opening on the upper side and below the air passage 90b opening on the lower side. These second coupling pins 98 project in the axial direction (the arrow C2 direction) from the tip, and are respectively fitted into pin holes (not illustrated) of the adjacent cover plate 50. As a result, the middle body 48 and the cover plate 50 are positioned so as to be in a predetermined position, and are coupled to each other by six fastening bolts 100 that will be mentioned later.

As shown in FIGS. 7 and 8, for example, the cover plate 50, which is formed in a plate shape having a constant thickness, is formed in a substantially rectangular shape covering the tip of the middle body 48, and includes a plurality of inner nozzle portions 102 that project from its tip. The inner nozzle portions 102, which are formed at a center in the height direction (the arrows D direction) of the cover plate 50, are provided so as to be separated by equal intervals from each other along the width direction (the arrows E direction), and project to a predetermined height in the axial direction (the arrow C2 direction).

Moreover, the cover plate 50 has, at its center in the height direction, a plurality of intermediate coating material passage portions 104 that penetrate in the axial direction, and these intermediate coating material passage portions 104, which are separated by equal intervals from each other along the width direction (the arrows E direction), have their base end sides communicating with the coating material passages 88 of the middle body 48, and have their tip sides penetrating insides of the inner nozzle portions 102 to open at their tips. The number of these intermediate coating material passage portions 104 is set at 10 so as to be the same number as the numbers of coating material passages 88 of the middle body 48 and inner nozzle portions 102.

Furthermore, the cover plate 50 has, at positions facing the tips of the air passages 90a, 90b of the middle body 48, a plurality of intermediate air passage portions 106. These intermediate air passage portions 106, which penetrate along the axial direction (the arrows C1, C2 direction) so that their tips open, are formed separated from each other in the upward and downward direction (the arrows D direction) sandwiching the intermediate coating material passage portions 104, and are formed separated by equal intervals from each other such that the intervals are the same as those of the intermediate coating material passage portions 104 in the width direction (the arrows E direction). That is, 10 intermediate air passage portions 106 are formed on each of upper and lower sides of the 10 inner nozzle portions 102 (intermediate coating material passage portions 104).

Moreover, in the cover plate 50, as shown in FIGS. 7 and 8, the six fastening bolts 100 are respectively inserted through a plurality of bolt holes 108 provided above and below the intermediate air passage portions 106, and are screwed into screw holes 110 of the middle body 48, whereby the cover plate 50 is coupled to the tip of the middle body 48.

Moreover, a gasket 112 surrounding the air passages 90a, 90b (the intermediate air passage portions 106) and the coating material passages 88 (the intermediate coating material passage portions 104) is provided between the cover plate 50 and the middle body 48, and this gasket 112 prevents leakage of air from between the air passages 90a, 90b, and prevents leakage of coating material from the coating material passages 88.

As a result, in the cover plate 50, the intermediate air passage portions 106 communicate with the air passages 90a, 90b of the middle body 48, and the intermediate coating material passage portions 104 communicate with the coating material passages 88.

The nozzle plate 52 is formed in a plate shape having a predetermined thickness with a rectangular shaped cross section, and has its planar-formed base end abutting on the tip of the cover plate 50 to be coupled thereto by fastening bolts 114 inserted through the cover plate 50 from its base end side (the arrow C1 direction).

On the other hand, as shown in FIGS. 6 to 8, the tip of the nozzle plate 52 is provided with a tip recess 116 that recedes toward the base end side (in the arrow C1 direction), and this tip recess 116 extends with the same cross-sectional shape along the width direction (the arrows E direction), and has, at its center in the height direction (the arrows D direction), a coating material discharge portion 118 that projects in the axial direction (the arrow C2 direction) from the tip.

As shown in FIGS. 6 to 8, the coating material discharge portion 118 projects to a predetermined height with a rectangular shaped cross section from the tip recess 116, and includes a plurality of discharge ports 120 through which coating material that has been mixed with air is discharged and which open linearly along the width direction (the arrows E direction).

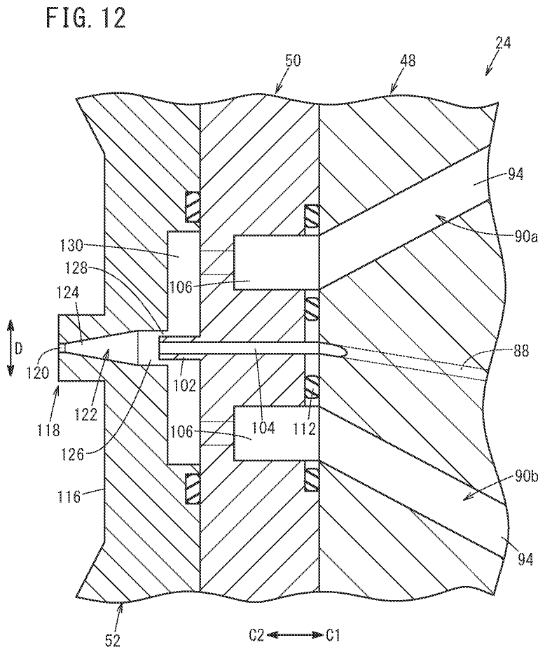

As shown in FIGS. 10 to 12, these discharge ports 120 are provided so as to be separated by equal intervals from each other along the width direction of the coating material discharge portion 118, extend in the axial direction with substantially a constant diameter in a circular shape in cross section, and are connected to tips of discharge passages 122 that will be mentioned later. Note that the number of the discharge ports 120 is the same as the number of the coating material passages 88 and the number of the intermediate coating material passage portions 104, that is, 10 discharge ports 120 are provided.

On the other hand, the nozzle plate 52 has on its inside a plurality of the discharge passages 122 that penetrate in the axial direction, and these discharge passages 122, which are formed at the center in the height direction, each include: a taper portion 124 formed on the tip side (in the arrow C2 direction) and connected to and communicating with the discharge port 120; and a merging portion 126 which is formed at a base end of the taper portion 124 and in which mixing of the coating material and air is performed, the discharge passages 122 being formed separated by equal intervals from each other along the width direction (the arrows E direction) of the nozzle plate 52 (refer to FIG. 10).

The taper portion 124 is formed so as to gradually taper from its base end toward its tip side (in the arrow C2 direction). The tip thereof where the diameter is smallest is connected to the discharge port 120 with the same diameter as the discharge port 120 and communicates therewith, and the base end thereof where the diameter is largest is connected to the merging portion 126 with the same diameter as the merging portion 126 and communicates therewith.

The merging portion 126 is formed with substantially a constant diameter along the axial direction (the arrows C1, C2 direction), and a tip of the inner nozzle portion 102 is inserted in the base end side thereof. As shown in FIGS. 10 to 12, an annular passage 128, which is annular in a radial direction, is formed between an outer circumferential surface of the inner nozzle portion 102 and an inner circumferential surface of the discharge passage 122. That is, the merging portion 126 is formed with a diameter which is larger than a diameter of the inner nozzle portion 102.

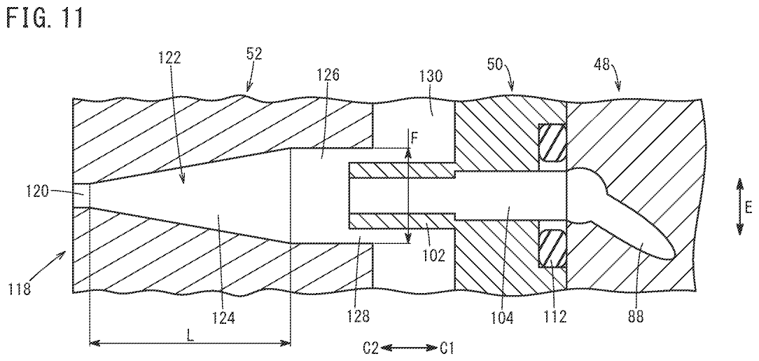

Moreover, as shown in FIG. 11, a diameter F of the merging portion 126 on the base end side (in the arrow C1 direction) is set so that a length L of the taper portion 124 along the axial direction is two or more times the diameter F (L≥2F).

Moreover, in this merging portion 126, the coating material supplied from the inner nozzle portion 102 (the intermediate coating material passage portion 104) and air supplied through the annular passage 128 are mixed in a predetermined mixing ratio.

Further still, the nozzle plate 52 includes an air gathering chamber 130 of substantially rectangular shape in cross section that opens on its base end side (in the arrow C1 direction), and this air gathering chamber 130 is formed so as to face and communicate with all of the intermediate air passage portions 106 (20 intermediate air passage portions 106) in the cover plate 50.

Moreover, the air gathering chamber 130 communicates with the annular passage 128 of each of the discharge passages 122 on its tip side. Then, air that has been supplied from the intermediate air passage portions 106 of the cover plate 50 is supplied to the annular passage 128 of each of the discharge passages 122 through the air gathering chamber 130. Then, the coating material and air that have been mixed in the merging portion 126 become coating material particles, and the coating material particles are sent out from the merging portion 126 to the taper portion 124 and the discharge port 120, and discharged to outside from this discharge port 120.

The coating device 10 according to the present embodiment is basically configured as above, and the case where the plurality of coating nozzles 24 are fitted to the frame 22 will be described next.

First, the coating nozzles 24 are disposed in the frame 22 shown in FIGS. 2 to 4 in such a manner that the body main body 46 of each of the coating nozzles 24 is located on the base portion 30 side, one side surface thereof including the pilot port 54 and so on is located on an outer side in the width direction, and the other side surface thereof including the positioning pin 86 is located on an inner side in the width direction.

Then, by the base ends of the body main bodies 46 being respectively inserted in the insertion holes 34 of the frame 22, the coating nozzles 24 are positioned in predetermined positions of the frame 22 such that the coating nozzles 24 are arranged in two columns in the width direction, each column including six coating nozzles 24 arranged along the longitudinal direction. Moreover, the coating nozzles 24 are disposed such that the projection 84 of one of the coating nozzles 24 adjacent in the width direction and the projection 84 of the other of the adjacent coating nozzles 24 face each other at the center in the width direction of the frame 22.

Next, the bar member 36 is inserted in a space formed between the projections 84 and the cover plates 50 of a set of the coating nozzles 24 shown in FIG. 4, and the positioning pins 86 of the coating nozzles 24 are inserted in the pin holes 42 of the bar member 36. This results in a state where, as shown in FIGS. 4 and 5, the coating nozzles 24 are each further positioned in the longitudinal direction and the width direction of the frame 22 by the long bar member 36.

Then, as shown in FIG. 5, both end portions of the bar member 36 are fixed by the fixing bolts 44 to the pair of legs 38 provided in the frame 22, whereby the 12 coating nozzles 24 are fixed in a state of having been certainly positioned by the frame 22 and the positioning portion 32, and the coating device 10, in which the plurality of coating nozzles 24 are continuously fitted to the frame 22, is configured.

Finally, the pilot port 54, the coating material supplying port 56, and the air supplying port 82 in each of the coating nozzles 24 are each connected with the coupler 58 and the tube 60, whereby a fitting operation is completed.

Next, the operation and operational advantages of the coating device 10, in which the plurality of coating nozzles 24 are fitted to the frame 22 as mentioned above, will be described.

The coating robot 12 installed with the coating device 10 shown in FIG. 1 operates the first and second arm portions 16, 18 under control action of an unillustrated controller so that the coating nozzles 24 of the coating device 10 are disposed in a predetermined position (for example, a position facing a coating surface of the target object W).

Then, coating material is supplied from the unillustrated coating material supplying device to the mixer 26 through piping, and distributed from this mixer 26 to each of the coating nozzles 24 through the plurality of tubes 60, and, at the same time, air is supplied from the unillustrated air supplying source to the pilot port 54 and the air supplying port 82 of each of the coating nozzles 24 through piping.

In each of the coating nozzles 24, pilot air that has been supplied to the pilot port 54 is supplied to the switching valve 66 through the first communicating channel 62, whereby the valve body moves in the axial direction and is brought into an open state. Then, coating material that has been supplied from the coating material supplying port 56 to inside the body main body 46 through the second communicating channel 64 is supplied from the communicating hole 70 to the coating material chamber 72 due to an opening operation of the valve body.

Then, the coating material that has been supplied to the coating material chamber 72 is supplied to the tip side (in the arrow C2 direction) through each of the 10 coating material passages 88. At this time, since the coating material passages 88 are formed to have the same diameter and substantially the same length, supplied amounts of the coating materials flowing to the tip side through the coating material passages 88 are substantially the same, and times for the supplied coating materials to reach the tip side are also substantially the same.

These coating materials flow to the tip side (in the arrow C2 direction) along the coating material passages 88 to be guided so as to gradually gather at the center in the height direction of the middle body 48 and so as to be separated by equal intervals from each other in the width direction of the middle body 48, and after having reached positions located at the center in the height direction and separated by equal intervals from each other in the width direction at the tip of the middle body 48, the coating materials are supplied to the intermediate coating material passage portions 104 of the cover plate 50. Since the number of these intermediate coating material passage portions 104 is 10, which is the same as the number of the coating material passages 88, the coating materials in the same amounts as the amounts of the coating materials from the coating material passages 88 are respectively supplied to the intermediate coating material passage portions 104.

Then, the coating material that has flowed to the tip of the inner nozzle portion 102 through the intermediate coating material passage portion 104 is guided out into the merging portion 126 of the discharge passage 122 in the nozzle plate 52.

On the other hand, air that has been supplied to the air supplying port 82 is supplied to the air passages 90a, 90b and the air chamber 74, then flows into each of the first and second air passage portions 92, 94 of the fork shaped air passages 90a, 90b to have its flow divided, and thereby flows toward the tip side (in the arrow C2 direction) from each of upper and lower sides.

Moreover, since the air passages 90a, 90b are formed so as to be symmetrically shaped in the height direction (the arrows D direction) of the coating nozzle 24 as shown in FIG. 8, the supplied amounts and times to reach the tip, of the air supplied to the tip side through the air passages 90a, 90b, are substantially the same, and the air whose flow has been divided flows so as to gradually approach the center in the height direction toward the tip side (in the arrow C2 direction).

Then, the air that has flowed to the tip of the middle body 48 flows into the plurality of intermediate air passage portions 106 in the cover plate 50 to undergo further flow division, after which the air is supplied to the air gathering chamber 130 of the nozzle plate 52. The air flows from this air gathering chamber 130 into the plurality of discharge passages 122, and flows into each of the annular passages 128 on outer sides of the inner nozzle portions 102, after which the air is supplied to each of the merging portions 126. As a result, the coating material that has been discharged from the inner nozzle portion 102 and the air from the annular passage 128 are mixed in a predetermined ratio in the merging portion 126.

The coating material particles formed by mixing the air and the coating material in this merging portion 126 are sent out to the tip side along the taper portion 124 tapering toward the tip, and discharged to outside from the tip through the discharge port 120. At this time, the taper portion 124 connecting the merging portion 126 and the discharge port 120 is formed in a tapered shape whose diameter gradually decreases from its base end side on the merging portion 126 side toward its tip side. Therefore, by the coating material being sent along the inner wall surface of this taper portion 124, ability-to-advance-linearly is enhanced, the air and coating material are more suitably mixed, and atomization of the coating material particles is thereby promoted.

The coating device 10 equally discharges the supplied coating material from the plurality of coating nozzles 24 onto the target object W, and the coating robot 12 moves the coating device 10 while discharging coating material particles from the coating device 10, whereby a coating film of desired thickness is formed on the target object W.

On the other hand, by supply of pilot air to the switching valve 66 being stopped, the valve body of the switching valve 66 moves to its initial position and is brought into a closed state, whereby communication of the coating material supplying port 56 and the coating material passages 88 is cut off. As a result, discharge of coating material from the discharge ports 120 is stopped. In this case, by continuing supply of air to the air supplying port 82, air alone is discharged to outside from the discharge ports 120. Therefore, for example, by discharging the air onto a coating film that has been coated on the surface of the target object W, it becomes possible to prompt drying of the coating film.

Note that the above-mentioned coating device 10 is not limited to the case of coating material being discharged simultaneously from all of the coating nozzles 24. For example, the coating device 10 may be configured to be capable of coating the coating material in a staggered manner by causing coating material to be discharged from every other coating nozzle 24 in the longitudinal direction (the arrows B direction) of the frame 22, and causing one of the coating nozzles 24 in the width direction and the other of the coating nozzles 24 in the width direction to alternately discharge coating material, by switching of the switching valve 66.

That is, by appropriately changing dispositions of the plurality of coating nozzles 24 with respect to the frame 22, according to a size or shape, a coating pattern, and so on, of the target object W to be coated by the coating device 10 including the plurality of coating nozzles 24, it becomes possible to perform coating easily and freely according to the shape, coating pattern, and so on.

As indicated above, in the present embodiment, in the coating nozzle 24 configuring the coating device 10, coating material is supplied to the coating material supplying port 56 of the body main body 46, and air is supplied to the air supplying port 82 of the middle body 48, and the nozzle plate 52 provided at the tip includes: the merging portion 126 for merging coating material and air; the plurality of discharge ports 120 for discharging coating material particles formed by mixing the coating material and the air from the merging portion 126; and the taper portion 124 which tapers from the merging portion 126 toward the tip side of the discharge port 120.

Thus, when coating material that has been supplied from the coating material supplying port 56 and air that has been supplied from the air supplying port 82 flow to the nozzle plate 52 side on the tip side, and are supplied to the discharge port 120 in a state of having been mixed in the merging portion 126, the coating material particles pass along the taper portion 124 tapering from the merging portion 126 toward the discharge port 120 side on the upstream side of the discharge port 120 to be suitably guided toward the discharge port 120 and discharged to outside, hence ability-to-advance-linearly of the discharged coating material particles can thereby be enhanced, and at the same time, atomization of the discharged coating material particles can thereby be improved.

As a result, a desired region in the target object W can be uniformly and efficiently coated by the coating device 10, and it thereby becomes possible for a shortening of manufacturing time to be achieved while a used amount of coating material is reduced.

Moreover, due to the length L of the taper portion 124 along the axial direction (the arrows C1, C2 direction) being set to be two or more times the diameter F on the upstream side of the merging portion 126, inclination of the taper portion 124 becomes more gentle, and ability-to-advance-linearly of the coating material particles flowing along the taper portion 124 can be more effectively enhanced, and at the same time, it becomes possible for atomization of the coating material particles to be even further promoted, compared to the case of less than two times.

Furthermore, by providing, on the upstream side of the merging portion 126, the intermediate coating material passage portion 104 along which the coating material is supplied on an inner side on an axis line, and the annular passage 128 along which air is supplied on an outer side of the intermediate coating material passage portion 104, the coating material and air can be merged in advance in the merging portion 126 within the nozzle plate 52, and stable coating material particles can be generated, hence further uniformization of the coating material discharged to outside can be achieved.

Further still, the plurality of coating material passages 88 are connected such that their base ends are separated by equal intervals from each other along the circumferential direction of the coating material chamber 72 which is formed in a circular shape in cross section, and the tips of the coating material passages 88 are disposed linearly along the width direction, whereby lengths of the coating material passages 88 are formed to be substantially the same.

As a result, it becomes possible for the coating material to be supplied to the tip side (in the arrow C2 direction) in substantially the same flow volumes along the plurality of coating material passages 88 from the coating material chamber 72, and the coating material can be uniformly discharged from the plurality of discharge ports 120, hence uniformity and stability of the coating film in the target object W can be enhanced.

Yet further, a structure supplying coating material and air is uniformized, and the merging portions 126 where the coating material and air merge are provided in a number corresponding to the discharge ports 120, whereby control of the flow volume of the discharged coating material and the pressure of the air can be easily performed, thereby enabling stable coating (ability-to-advance-linearly, uniformity) of the coating material.

Note that the coating nozzle according to the present invention is not limited to the above-mentioned embodiment, and it goes without saying that a variety of configurations may be adopted without departing from the spirit of the present invention.

What is claim is:

1. A coating nozzle comprising: coating material supplying channels configured to supply a coating material; fluid supplying channels configured to supply a fluid; and a body in which the coating material supplying channels and the fluid supplying channels are connected, the body being provided with a merging portion configured to merge and mix the coating material and the fluid, and at least one discharge port configured to discharge the coating material and the fluid in a mixed state from the merging portion, wherein
the body includes, on an inside thereof, the merging portion, the discharge port, and a taper portion that tapers from the merging portion toward a tip side of the discharge port.

2. The coating nozzle according to claim 1, wherein
a length of the taper portion along an axial direction is set to be two or more times an upstream side diameter of the merging portion.

3. The coating nozzle according to claim 1, wherein
on an upstream side of the merging portion, the coating material supplying channels are formed on an inner side on an axis line of the merging portion, and the fluid supplying channels are formed on an outer side of the coating material supplying channels.

4. The coating nozzle according to claim 1, wherein
the coating material supplying channels are disposed substantially circumferentially within the body and connected to a coating material passage, and are disposed linearly in a direction orthogonal to an axis line from the coating material passage toward the merging portion, and lengths of the coating material supplying channels are set to be substantially identical to each other.

5. The coating nozzle according to claim 3, wherein
the merging portion is provided in a number corresponding and identical to a number of the discharge ports.
